(19) United States
(12) Patent Application Publication
(10) Pub. No.: US 2008/0218482 A1
(43) Pub. Date: Sep. 11, 2008

(54) Input apparatus

(75) Inventors: Jyun-Jie Yang, Tao-yuan City (TW); Chien-Chi Chen, Taipei City (TW)

Correspondence Address: BIRCH STEWART KOLASCH & BIRCH, PO BOX 747, FALLS CHURCH, VA, 22040-0747, US

(73) Assignee: Qisda Corporation

(21) Appl. No.: 12/073,531

(22) Filed: Mar. 6, 2008

(30) Foreign Application Priority Data
Mar. 9, 2007 (TW) 096108165

(51) Int. Cl. G06F 3/02

(52) U.S. Cl. 345/168

(57) ABSTRACT

The invention provides an input apparatus, which includes a signal-scanning line, a plurality of signal-outputting lines, an output end, and a plurality of first keys. In addition, the signal-scanning line has a first signal level, whereas each of the signal-outputting lines has a second signal level. Moreover, the output end is coupled with each of the signal-outputting lines and determines a key code based on the signal level of the signal-outputting lines. Furthermore, each of the first keys has at least three contacts, one of which is coupled with the signal-scanning line, and the others are selectively coupled with the signal-outputting lines. Particularly, when one of the first keys is pressed, the contacts and signal-outputting lines corresponded to the pressed first keys has the first signal level.

### BACKGROUND OF THE INVENTION

1. Field of the Invention

The present invention relates to an input apparatus and, more particularly, to a key input apparatus.

2. Description of the Prior Art

Current electronic apparatus/systems, such as mobile phones, business machines, digital cameras, and notebooks, have input apparatus with a number of keys for a user to operate the electronic apparatus/system. With the increasing of functionalities of the electronic apparatus/systems, the number of keys needs to be increased to provide the user to utilize the functionalities.

Please refer to FIG. 1A and FIG. 1B. FIG. 1A shows an input apparatus of the prior art, and FIG. 1B shows the signal levels of signal-outputting lines 562 of the input apparatus 5 and the corresponded key codes of the input apparatus of FIG. 1A.

As shown in FIG. 1A, the input apparatus 5 of the prior art includes certain keys 52, a signal-scanning line 542, and an output end 56. Furthermore, the signal-scanning line 542 has a first signal level. The output end 56 is coupled with a plurality of signal-outputting lines 562 which each has a second signal level. Each of the keys 52 has a first contact 522a and a second contact 522b; moreover, the first contact 522a is coupled to the signal-scanning line 542, and the second contact 522b is selectively coupled to one of the signal-outputting lines 562. When the key 52 is pressed, the contacts 522 of the key 52 and the corresponded signal-outputting line will have the same first signal level as the signal-scanning line 542.

For example, assume that the signal-scanning line 542 of FIG. 1A has the lower first signal level “0”, and each of the signal-outputting lines 562a˜562e has the second signal level “1” higher than the first signal level. When the most right key 52 in FIG. 1A is pressed, the corresponded signal-scanning line 562e has the first signal level, and the signal-outputting lines 562a˜562e have signal levels 1, 1, 1, 1, and 0 respectively. According to FIG. 1B, the key code determined by the output end 56 according to the signal levels is “5”. In another example, when the most left key in FIG. 1A is pressed, the corresponded signal-scanning line 562a has the first signal level, and the signal-outputting lines 562a˜562e have signal levels 0, 1, 1, 1, and 1 respectively. According to FIG. 1B, the key code determined by the output end 56 according to the signal levels is “1”. By this mechanism, the input apparatus 5 of FIG. 1A containing these five signal-outputting lines 562 can determine five key codes.

Obviously, the number of key codes can be increased by simply adding signal-scanning lines or signal-outputting lines to provide more functions for users. However, increasing the keys means the increase of corresponded signal-outputting lines at the output end, and the electronic apparatus/system needs more space to contain the signal-outputting lines, so the complexity and cost of design are also increased. Furthermore, too many signal-outputting lines will occupy the bandwidth of the electronic apparatus/system. Accordingly, how to increase the number of keys but not the loading of the electronic apparatus/system has become an important problem that needs to be solved in the related field.

Please refer to FIG. 2. FIG. 2 shows an input apparatus of the prior art. As shown in FIG. 2, the input apparatus 7 also has five signal-outputting lines 762a˜762e. However, the signal-outputting lines 762 are arranged as a 2×3 array. Therefore, the input apparatus 7 can determine one more key code than the input apparatus 5 of FIG. 1A without increasing the number of signal-scanning line or signal-outputting line. Take an example for seven signal-outputting lines; with the arrangement of FIG. 1, these seven signal-outputting lines can arrange 7 keys, whereas with the arrangement of FIG. 2, these seven signal-outputting lines can arrange 3×4=12 keys.

However, the input apparatus 7 of FIG. 2 still can not handle the demands of largely increased electronic apparatus/system.

### SUMMARY OF THE INVENTION

Accordingly, an objective of the invention is to provide an input apparatus for solving the above-mentioned problems. Particularly, the input apparatus of the invention can effectively determine more key codes, so as to reduce the time for electronic device/systems to confirm the status of each key.

According to the first preferred embodiment, the input apparatus of the invention includes a signal-scanning line, a plurality of signal-outputting lines, an output end, and a plurality of first keys. Furthermore, the signal-scanning line has a first signal level, whereas each of the plurality of signal-outputting lines has a second signal level. The output end is coupled to the plurality of signal-outputting lines, and the output end determines a key code according to the signal level of the coupled signal-outputting lines. Furthermore, each of the first keys has at least three contacts, wherein one of the contacts is coupled to the signal-scanning line, and the other contacts are selectively coupled to the signal-outputting lines. Particularly, when one of the first keys is pressed, the contacts of the pressed first key and its corresponding signal-outputting lines have the first signal level.

According to the second preferred embodiment, the input apparatus of the invention includes a signal-scanning line, a plurality of signal-outputting lines, a first key, and an output end. Furthermore, the signal-scanning line has a first signal level, whereas each of the plurality of signal-outputting lines has a second signal level. Furthermore, the first key has a first contact and at least two second contacts; the first contact is coupled to the signal-scanning line, and the at least two second contacts are selectively coupled to the plurality of signal-outputting lines. When the first key is pressed, the signal-outputting lines corresponding to the at least two second contacts have the first signal level. Additionally, the output end is coupled to the plurality of signal-outputting lines for determining a key code.

The advantage and spirit of the invention may be further understood by the following recitations together with the appended drawings.

### BRIEF DESCRIPTION OF THE APPENDED DRAWINGS

FIG. 1A shows an input apparatus of the prior art.

FIG. 1B shows the signal levels of the signal-outputting lines and corresponded key codes of the input apparatus of FIG. 1A.

FIG. 2 shows an input apparatus of the prior art.

FIG. 3A shows an input apparatus according to an embodiment of the invention.

FIG. 3B shows the signal levels of the signal-outputting lines and the corresponded key codes of the input apparatus of FIG. 3A.

FIG. 4A shows an input apparatus according to an embodiment of the invention.

FIG. 4B shows the signal levels of the signal-outputting lines and the corresponded key codes of the input apparatus of FIG. 4A.

FIG. 5 shows an input apparatus 1 in according to an embodiment of the invention.

FIG. 6 shows an input apparatus according to an embodiment of the invention.

FIG. 7 shows an input apparatus according to another embodiment of the invention.

### DETAILED DESCRIPTION OF THE INVENTION

The invention provides an input apparatus. The embodiments of the invention are disclosed below.

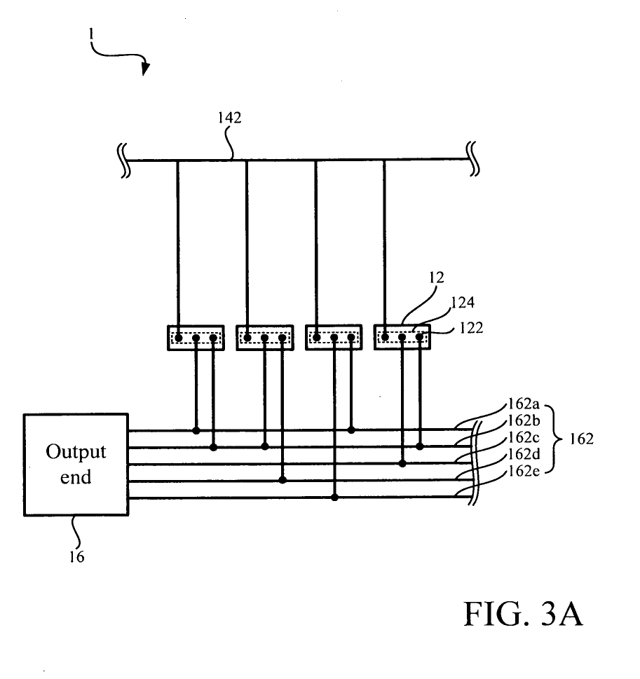

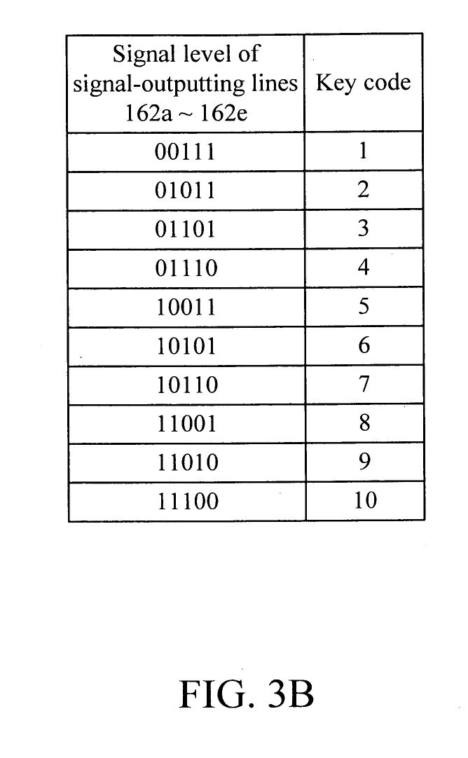

Please refer to FIG. 3A. FIG. 3A shows an input apparatus according to an embodiment of the invention. In the embodiment, the input apparatus 1 of the invention includes a signal-scanning line 142, five signal-outputting lines 162 (162a, 162b, 162c, 162d, and 162e), an output end 16, and four first keys 12.

Furthermore, the signal-scanning line 142 has a first signal level, and each of the signal-outputting lines 162a˜162e has a second signal level. The output end 16 is coupled to the signal-outputting lines 162, and the output end 16 determines a key code based on the signal level of the signal-outputting lines 162. Please further refer to FIG. 3B. FIG. 3B shows the signal levels of the signal-outputting lines 162 and the corresponded key codes of the input apparatus 1 of FIG. 3A.

Moreover, each of the first keys 12 has three contacts 122 and a conductive terminal 124. One of the contacts 122 is coupled to the signal-scanning line 142, and other contacts 122 is selectively coupled to the signal-outputting lines 162. Particularly, when one of the first keys 12 is pressed, the conductive terminal 124 touches the contacts 122, and the signal level of the contacts 122 and signal-outputting lines 162 corresponded to the first key 12 is changed to the first signal level.

For example, assume that the signal-scanning line 142 of FIG. 3A is grounded and has a lower first signal level “0”, and each of the signal-outputting lines 162a˜162e has a second signal level “1” higher than the first signal level. When the most right first key of FIG. 3A is pressed, the conductive terminal 124 touches these three contacts 122 at the same time, so as to let these three contacts 122 and signal-outputting lines 162b and 162c have the first signal level “0”. Moreover, signal-outputting lines 162a˜162e have signal levels 1, 0, 0, 1, and 1 respectively. According to FIG. 3B, the output end 16 can determine the key code as “5” based on the signal levels. In another example, when the most left first key of FIG. 3A is pressed, both of the signal-outputting lines 162a and 162b have the first signal level “0”, which is the same as the signal scanning line 142. Moreover, the signal-outputting lines 162a˜162e have signal levels 0, 0, 1, 1, and 1 respectively. According to FIG. 3B, the output end 16 can determine the key code as “1” based on the signal levels.

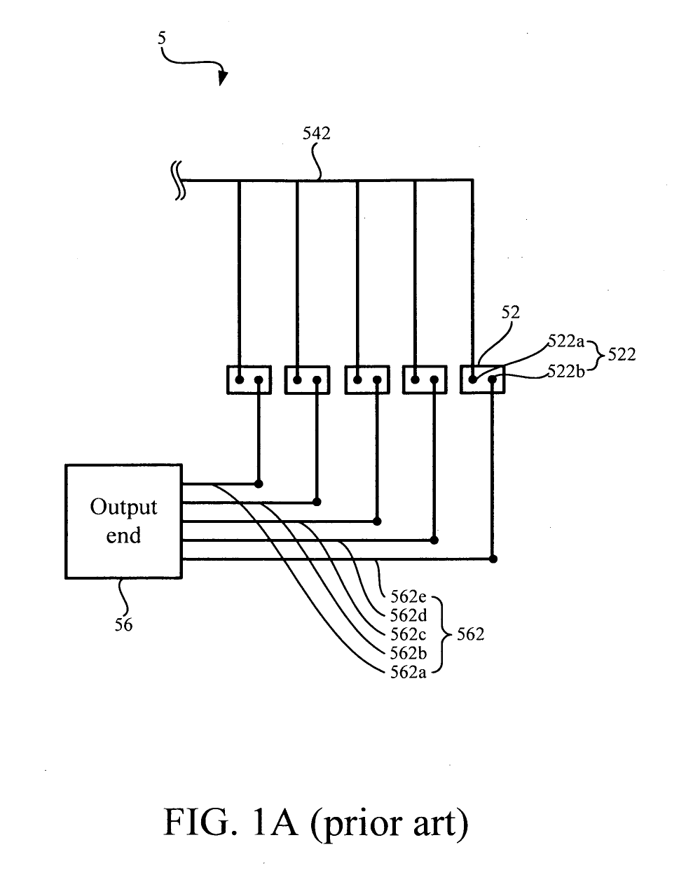

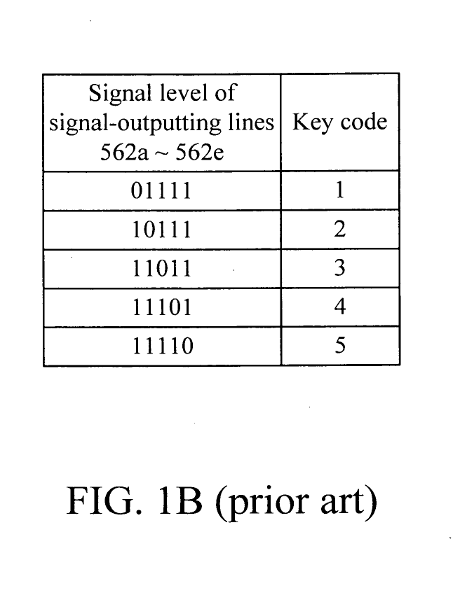

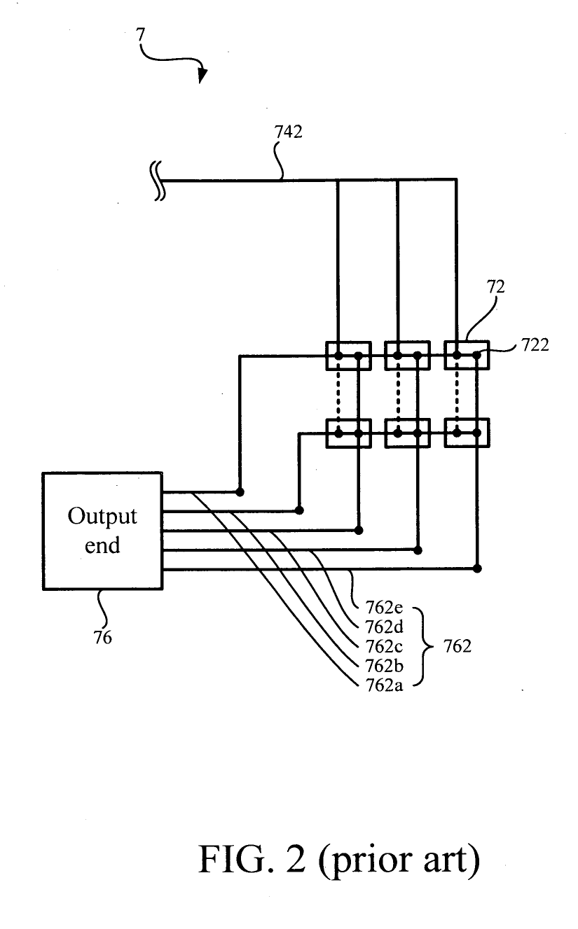

In other words, the output end 16 of FIG. 3A can determine a total of ten key codes based on these five signal-outputting lines 162. Compared with the conventional input apparatus 5 of FIG. 1A which can only determine five key codes, and the conventional input apparatus 7 of FIG. 2A which can only determine six key codes, the input apparatus 1 of the invention can obviously determine more key codes.

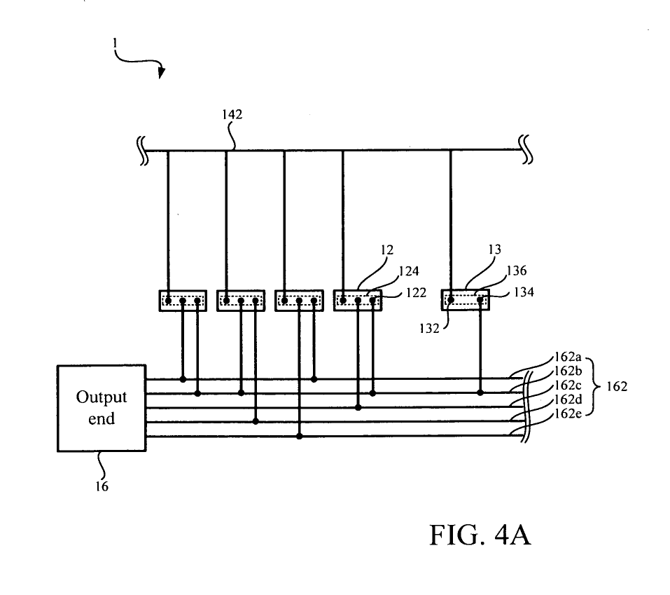

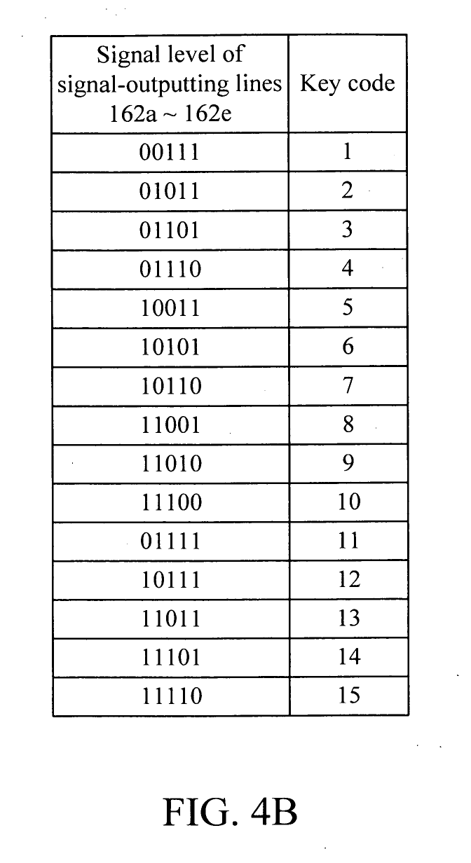

Please refer to FIG. 4A. FIG. 4A shows an input apparatus according to an embodiment of the invention. In the embodiment, the input apparatus 1 of the invention can further include a plurality of second keys 13. Moreover, each of the second keys 13 has a first contact 132, a second contact 134, and a conductive terminal 136, wherein the first contact 132 is coupled to the signal-scanning line 142, and the second contact 134 is selectively coupled to the signal-outputting lines 162. Additionally, when one of the second keys 13 is pressed, the conductive terminal 136 touches the first contact 132 and the second contact 134 and lets the signal-outputting line 162 corresponded to the second contact 134 have the first signal level. Please further refer to FIG. 4B. FIG. 4B shows the signal levels of the signal-outputting lines 162 and the corresponded key codes of the input apparatus 1 of FIG. 4A.

For example, assume that the signal-scanning line 142 of FIG. 4A has a lower first signal level “0”, and each of the signal-outputting lines 162a˜162e has a second signal level “1” higher than the first signal level. When the most right second key 13 of FIG. 4A is pressed, the conductive terminal 136 touches the first contact 132 and the second contact 134 at the same time, so as to let these two contacts 132 and 134 and the signal-outputting lines 162b have the first signal level “0”, which is the same as the signal scanning line 142. Moreover, the signal-outputting lines 162a˜162e have signal levels 1, 0, 1, 1, and 1 respectively. According to FIG. 4B, the output end 16 can determine the key code as “12” based on the signal levels.

Furthermore, the output end 16 of FIG. 4A can determine a total of fifteen key codes based on these five signal-outputting lines 162. Compared with the conventional input apparatus 5 of FIG. 1A and the conventional input apparatus 7 of FIG. 2A, the input apparatus 1 of the invention can obviously determine more key codes.

Please note that the signal level of signal-outputting lines 162 and the corresponded key codes can be suitably pre-set in accordance with the system, such as personal computer, photocopier, and fax machine, which the input apparatus 1 is applied to, but it is not limited by the above-mentioned examples.

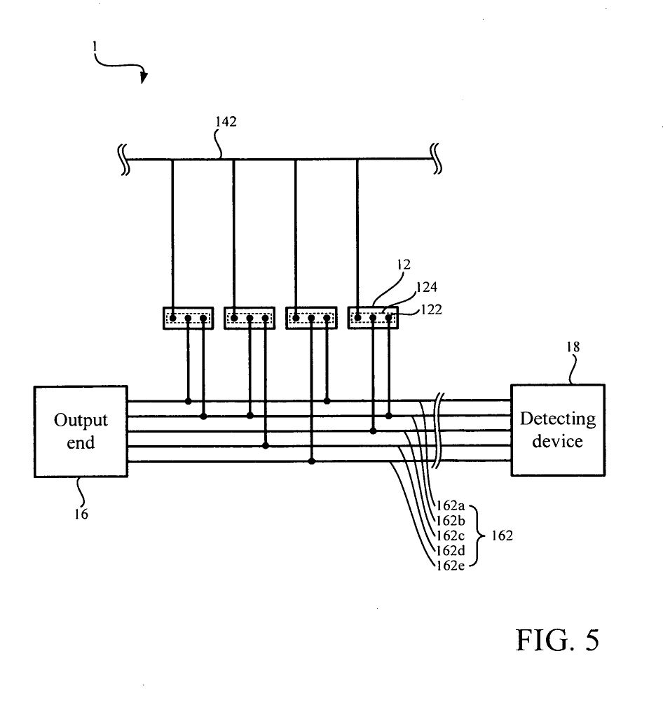

Please refer to FIG. 5. FIG. 5 shows an input apparatus 1 according to an embodiment of the invention. As shown in FIG. 5, the input apparatus 1 of the invention can further include a detecting device 18, electrically connected to the plurality of signal-outputting lines 162, for detecting the signal level of each of the signal-outputting lines 162a˜162e.

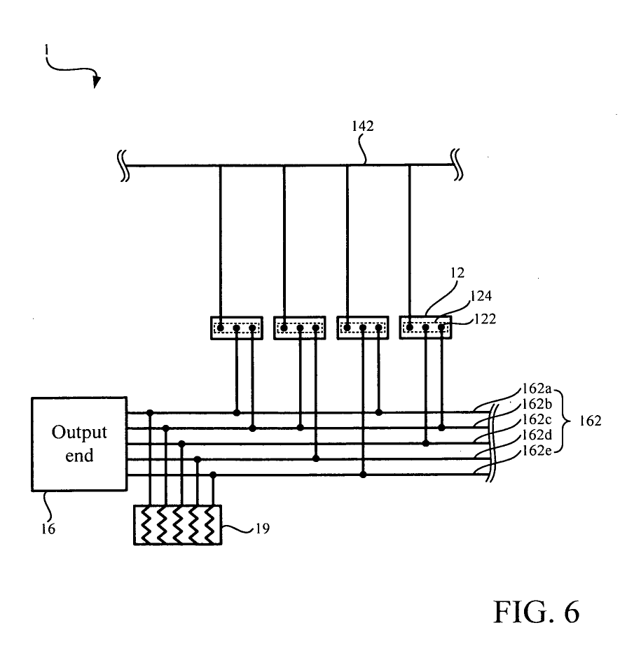

Please refer to FIG. 6. FIG. 6 shows an input apparatus 1 according to an embodiment of the invention. As shown in FIG. 6, the input apparatus 1 of the invention can further include a plurality of first resistors 19, such as current-limiting resistors, coupled to the signal-outputting lines 162a˜162e respectively, and one end of the plurality of first resistors 19 is coupled to a voltage source (not shown), so as to provide the second signal level to the signal-outputting lines 162.

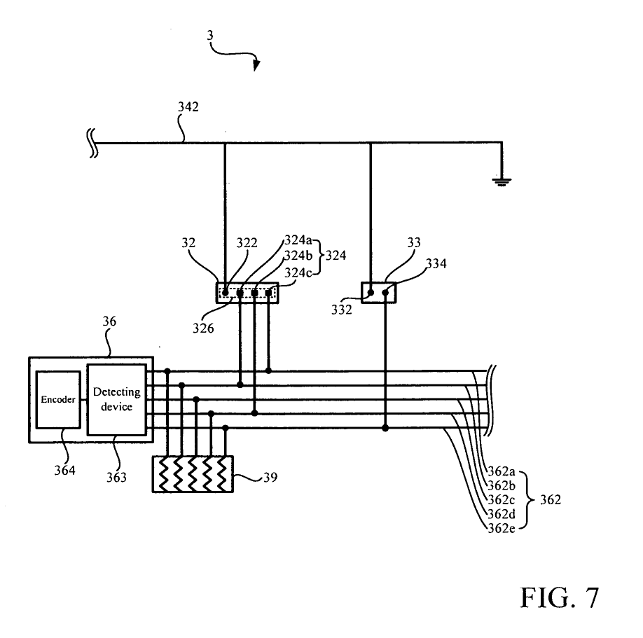

Please refer to FIG. 7. FIG. 7 shows an input apparatus 1 according to another embodiment of the invention. In the embodiment, the input apparatus 3 includes a signal-scanning line 342, a plurality of signal-outputting lines 362, a first key 32, and an output end 36. Furthermore, the signal-scanning line 342 (grounded) has a first signal level, whereas all of the signal-outputting lines 362 have a second signal level. In practice, the second signal level can be optionally higher or lower than the first signal level.

Furthermore, the first key 32 has a first contact 322 and at least two second contacts 324 (in the embodiment, the first key 32 has three second contacts 324), and the first contact 322 is coupled to the signal-scanning line 342, whereas the second contacts 324 are selectively coupled to the plurality of signal-outputting lines 362 (in the embodiment, the second contact 324a is coupled to the signal-outputting line 362b; the second contact 324b is coupled to the signal-outputting line 362d, and the second contact 324c is coupled to the signal-outputting line 362a).

Particularly, when the first key 32 is pressed, the signal-outputting lines 362b, 362d, and 362a, each corresponding to the second contacts 324a, 324b, and 324c, have the first signal level. Furthermore, the output end 36 is coupled to the signal-outputting lines 362, and the output end 36 includes a detecting device 363 and encoder 364. The detecting device 363 is electrically connected to the signal-outputting lines 362, for detecting the signal level of each of the signal-outputting lines 362a˜362e. The encoder 364 can store a plurality of key codes and signal levels corresponded to the key codes, and the encoder 364 can determine the key code in accordance with the signal levels of the coupled signal-outputting lines 362.

In the embodiment, the first key 32 also includes a conductive terminal 326. When the first key 32 is pressed, the conductive terminal 326 touches the first contact 322 and the second contacts 324, so as to let the signal-outputting lines 362 corresponded to the second contacts 324 have the first signal level.

In the embodiment, the input apparatus 3 further includes at least one second key 33. Moreover, the second key 33 has a first contact 332 and a second contact 334. The first contact 332 is coupled to the signal-scanning line 342, whereas the second contact 334 is selectively coupled to one (362e) of the signal-outputting lines 362. When the second key 33 is pressed, the signal-outputting line 362e corresponded to the second contact 334 has the first signal level.

In the embodiment, the input apparatus 3 of the invention further includes a plurality of first resistors 39, such as current-limiting resistors, coupled to the signal-outputting lines 362 respectively, and one end of the plurality of first resistors 39 is coupled to a voltage source (not shown), so as to provide the second signal level to the signal-outputting lines 362.

Please note that the number of the signal-outputting lines 362, the first keys 32 and the second contacts 324 of the first keys 32, and the second keys 33 and the second contacts 334 of the second keys 33, can be optionally adjusted but not limited to the number illustrated above.

As described above, compared with the input apparatus of the prior art, the input apparatus of the invention has higher flexibility and can significantly determine more key codes.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. An input apparatus comprising:
a signal-scanning line having a first signal level;
a plurality of signal-outputting lines which each has a second signal level;
an output end, coupling to the plurality of signal-outputting lines, for determining a key code in accordance with the signal level of the signal-outputting lines; and
a plurality of first keys which each has at least three contacts, wherein one of the contacts couples to the signal-scanning line, and the other contacts selectively couple to the signal-outputting lines;
wherein when one of the first keys is pressed, the contacts of the pressed first key and the signal-outputting lines corresponding to the contacts having the first signal level.

2. The input apparatus of claim 1, wherein each of the plurality of first keys further comprises a conductive terminal, and when the first key is pressed, the conductive terminal contacting the at least three contacts, so as to change the signal level of the corresponding signal-outputting lines to the first signal level.

3. The input apparatus of claim 1, wherein the second signal level is higher than the first signal level.

4. The input apparatus of claim 1, further comprising:
a plurality of second keys which each has a first contact and a second contact, wherein the first contact couples to the signal-scanning line, and the second contact selectively coupling to the signal-outputting lines;
wherein when one of the second keys is pressed, the signal-outputting lines corresponding to the second contact having the first signal level.

5. The input apparatus of claim 1, wherein the output end further comprises a detecting device, electrically connected to the plurality of signal-outputting lines, for detecting the signal level of each the signal-outputting lines.

6. The input apparatus of claim 1, wherein the signal-scanning line is grounded.

7. The input apparatus of claim 1, further comprising a plurality of first resistors which each couples to one of the signal-outputting lines, and one end of the plurality of first resistors coupling to a voltage source, so as to provide the second signal level to the signal-outputting lines.

8. The input apparatus of claim 7, wherein the first resistors are current-limiting resistors.

9. An input apparatus comprising:
a signal-scanning line having a first signal level;
a plurality of signal-outputting lines which each has a second signal level;
a first key having a first contact and at least two second contacts, the first contact coupling to the signal-scanning line, and the at least two second contacts selectively coupling to the plurality of signal-outputting lines, wherein when the first key is pressed, the signal-outputting lines corresponding to the at least two second contacts having the first signal level; and
an output end, coupling to the plurality of signal-outputting lines, for determining a key code.

10. The input apparatus of claim 9, wherein the output end further comprising:
an encoder, storing a plurality of key codes and signal levels corresponding to the key codes, the encoder determining the key code in accordance with the signal levels of the coupled signal-outputting lines.

11. The input apparatus of claim 9, wherein each of the plurality of first keys further comprises a conductive terminal, and when the first key is pressed, the conductive terminal contacting the first contact and the at least two second contacts, so as to change the signal level of the signal-outputting lines corresponding to the at least two second contacts to the first signal level.

12. The input apparatus of claim 9, wherein the second signal level is higher than the first signal level.

13. The input apparatus of claim 9, further comprising:
a plurality of second keys which each has a first contact and a second contact, wherein the first contact couples to the signal-scanning line, and the second contact selectively couples to the signal-outputting lines;
wherein when one of the second keys is pressed, the signal-outputting lines corresponding to the second contact having the first signal level.

14. The input apparatus of claim 9, wherein the output end further comprises a detecting device, electrically connected to the plurality of signal-outputting lines, for detecting the signal level of each the signal-outputting lines.

15. The input apparatus of claim 9, wherein the signal-scanning line is grounded.

16. The input apparatus of claim 9, further comprising a plurality of first resistors which each couples to one of the signal-outputting lines, and one end of the plurality of first resistors couple to a voltage source, so as to provide the second signal level to the signal-outputting lines.

17. The input apparatus of claim 16, wherein the first resistors are current-limiting resistors.
